(19) United States
(12) Patent Application Publication
(10) Pub. No.: US 2025/0284886 A1
(43) Pub. Date: Sep. 11, 2025

(54) CAUSALLY-AWARE ATTRIBUTE CONTROLLED STATEMENT GENERATION IN LANGUAGE MODELS

(71) Applicant: International Business Machines Corporation, Armonk, NY (US)

(72) Inventors: Kahini Wadhawan, Ferozepur (IN); Rahul Madhavan, Koramangala (IN); Rishabh Garg, Navi Mumbai (IN); Sameep Mehta, Bangalore (IN); Vijay Arya, Gurgaon (IN)

(21) Appl. No.: 18/354,956

(22) Filed: Jul. 19, 2023

(51) Int. Cl. G06F 40/284

(52) U.S. Cl. CPC G06F 40/284

(57) ABSTRACT

Various systems and methods are presented regarding reducing/mitigating generation of one or more statements by a language model (LM), wherein the statements can be any of toxic, offensive, biased, etc. A statement automatically generated by the LM, e.g., in response to a prompt, can be assessed with regard to a probability of the statement being associated with a negative attribute(s). The statement can be further reviewed to identify tokens within the statement causing the association with the negative attribute(s). The tokens can be replaced with counterfactuals, and further assessment(s) made to determine the effect of the statement having a token replaced by a counterfactual with regard to probability of the modified statement being associated with the attribute. The LM can undergo further finetuning to mitigate generation of an offensive statement being generated by the LM.

### BACKGROUND

The subject disclosure relates to language models (LMs), and more specifically to operation of LMs.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

In one or more embodiments described herein, systems, devices, computer-implemented methods, methods, apparatus and/or computer program products are presented that facilitate reducing/mitigating generation of one or more statements by a language model (LM), wherein the statements can be any of toxic, offensive, biased, etc.

According to one or more embodiments, a system is provided to modify operation of a LM. The system can comprise at least one processor, and a memory coupled to the at least one processor and having instructions stored thereon, wherein, in response to the at least one processor, the instructions facilitate performance of operations, comprising determining whether the LM is generating a first statement having an unacceptable first probability of being associated with an attribute. In an embodiment, the operations can further comprise identifying a first token and a second token in a second statement causing the second statement to be associated with the attribute, wherein the second statement is generated by the LM. In an embodiment, the attribute can indicate the statement is at least one of toxic, abusive, offensive, demeaning, malicious, biased, or harmful. In another embodiment, the LM can be trained with data generated web-crawled data. In another embodiment, the LM can be a large language model.

In a further embodiment, the operations can further comprise replacing the first token in the second statement with a first counterfactual to create a first partially modified statement, and determining a second probability of the first partially modified statement being associated with the attribute. In a further embodiment, the operations can further comprise replacing the first token in the second statement with a second counterfactual to create a second partially modified statement, and determining a third probability of the second partially modified statement being associated with the attribute. In another embodiment, the operations can further comprise generating a first average treatment effect (ATE) score based on an average of the second probability and the third probability, and storing the first ATE score in a lookup table, wherein the first ATE score is stored with the first token. In a further embodiment, the operations can further comprise any of: (i) replacing the second token in the second statement with a third counterfactual to create a third partially modified statement, (ii) determining a fourth probability of the third partially modified statement being associated with the attribute, (iii) replacing the second token in the second statement with a fourth counterfactual to create a fourth partially modified statement, (iv) determining a fifth probability of the fourth partially modified statement being associated with the attribute, (v) generating a second ATE score based on an average of the fourth probability and the fifth probability, and (vi) storing the second ATE score in the lookup table, wherein the ATE score is stored with the second token.

In a further embodiment, the operations can further comprise receiving the first statement, identifying the first token and second token in the first statement; and determining a structural causal model (SCM) score for the first statement, wherein the SCM score comprises a combination of the first ATE score and the second ATE score.

In a further embodiment, the operations can further comprise comparing the SCM score with a threshold value, wherein in the event of the SCM score has a value greater than the threshold value, the language model is identified as generating one or more statements having an unacceptable level of association with the attribute, or in the event of the SCM score has a value less than the threshold value, the language model is identified as generating one or more statements having an acceptable level of association with the attribute.

In other embodiments, elements described in connection with the disclosed systems can be embodied in different forms such as computer-implemented methods, computer program products, or other forms. In an embodiment, the computer-implemented method can comprise modifying, by a device comprising a processor, operation of a language model (LM) to generate a first statement having an acceptable probability of association with an attribute. In a further embodiment, the computer-implemented method can further comprise generating, by the device, a vocabulary for the LM, wherein the vocabulary comprises respective tokens identified in statements generated by the LM, the respective tokens have an associated average treatment effect (ATE) score, wherein a respective ATE score is derived from one or more treatment effect (TE) scores determined for the respective token.

In a further embodiment, the computer-implemented method can further comprise identifying in the first statement a first token and a second token, identifying a first ATE score for the first token and a second ATE score for the second token, generating a structural causal model (SCM) score for the statement, wherein the SCM score is a combination of the first ATE score and the second ATE score; and comparing the SCM score with a threshold, wherein: in the event of the SCM score exceeds the threshold, the first statement has an unacceptable probability of association with the attribute; and in the event of the SCM score does not exceed the threshold, the first statement has an acceptable probability of association with the attribute. In an embodiment, the attribute can indicate the statement is at least one of toxic, abusive, offensive, hateful, demeaning, malicious, biased, or harmful.

Another embodiment can further comprise a computer program product stored on a non-transitory computer-readable medium and comprising machine-executable instructions, wherein, in response to being executed, the machine-executable instructions cause a machine to perform operations, comprising modifying operation of a language model (LM) to generate a first statement having an acceptable probability of association with an attribute. In a further embodiment, the operations can further comprise generating, by the device, a vocabulary for the LM, wherein the vocabulary comprises respective tokens identified in statements generated by the LM, the respective tokens have an associated average treatment effect (ATE) score, wherein a respective ATE score is derived from one or more treatment effect (TE) scores determined for the respective token.

In a further embodiment, the operations can further comprise any of (i) identifying in the first statement a first token and a second token, (ii) identifying a first ATE score for the first token and a second ATE score for the second token, (iii) generating a structural causal model (SCM) score for the statement, wherein the SCM score is a combination of the first ATE score and the second ATE score, and (iv) comparing the SCM score with a threshold, wherein: in the event of the SCM score exceeds the threshold, the first statement has an unacceptable probability of association with the attribute; and in the event of the SCM score does not exceed the threshold, the first statement has an acceptable probability of association with the attribute. In an embodiment, the attribute can indicate the statement is at least one of toxic, abusive, offensive, demeaning, malicious, biased, or harmful. In a further embodiment, the LM can be trained with data generated web-crawled data.

### DESCRIPTION OF THE DRAWINGS

One or more embodiments are described below in the Detailed Description section with reference to the following drawings:

FIG. 1 illustrates a system that can be utilized to detoxify/un-bias a LM, in accordance with one or more embodiments.

FIG. 2 illustrates a system which can be utilized to detoxify/un-bias a language model, in accordance with an embodiment.

FIG. 3 illustrates replacement of tokens in a statement with respective counterfactuals, in accordance with one or more embodiments.

FIG. 4 presents a system model pipeline utilized to detoxify/un-bias a LM, in accordance with one or more embodiments.

FIG. 5 illustrates an example representation of a causal model as utilized to generate an attribute score of a statement, in accordance with an embodiment.

FIG. 6 illustrates an example representation of a SCM configured to modify/modifying operation of an LM to reduce probability of the LM generating toxic statements, in accordance with an embodiment.

FIGS. 7A-7B present a computer-implemented methodology to mitigate generation of negative-attribute statements by a LM, according to one or more embodiments.

FIG. 8 illustrates a computer-implemented methodology to determine one or more tokens in a statement that may be causing the statement to be offensive, according to one or more embodiments.

FIG. 9 presents a plot of Expected Maximum Toxicity for various completed statements, in accordance with an embodiment.

FIG. 10 presents a plot of Probability of Toxicity Gain for various completed statements, in accordance with an embodiment.

FIG. 11 depicts an example schematic block diagram of a computing environment with which the disclosed subject matter can interact/be implemented at least in part, in accordance with various aspects and implementations of the subject disclosure.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### TERMS

Attribute: describes/quantifies respective statements, tokens, terms, etc., wherein an attribute can be, in a non-limiting list: toxic, abusive, offensive, demeaning, malicious, biased, harmful, and suchlike.

Bias: can result from LLMs engendering spurious correlations as a result of pattern recognition. For example, in a training dataset, there are many hateful statements directed towards a societal group 1, accordingly, an LLM could consistently apply the term societal group 1 in a potentially hateful manner. In another example, in a training dataset, there are many demeaning statements directed toward societal group 2, accordingly, an LLM could consistently apply the term societal group 2 in a potentially demeaning way. In a further example, in a training dataset, there are many unfounded, yet toxic, statements relating to a societal group 3 to have, for example, low intelligence quotient (IQ), accordingly, an LLM may recognize this pattern and apply it to classification functions such as hiring or not hiring based on automated resume reading by the LLM, whereby the LLM is biased against hiring societal group 3.

Counterfactual: words/terms can be selected to determine whether a token in a statement from an LLM has a causal effect on an attribute classified for the statement. In an embodiment, a counterfactual can have the opposite meaning of a token in a statement or the counterfactual can be a related term, e.g., token=white, counterfactual=black; token=unintelligent, counterfactual=intelligent; token=firstpeople, counterfactual=secondpeople, such that replacing firstpeople with secondpeople changes the demographic of the respective group of people; and suchlike.

Statement: a statement, sentence, textual string, etc., generated by a LLM, e.g., in response to an input. In an example, the input can be a question, wherein the LLM generates, in response to the question, a statement comprising an answer statement. In another example, the input can be a request to complete a statement, wherein the LLM generates, in response to the request, a statement comprising the completed statement. In another example, a statement can be generated in response to a specific prompt applied to the LLM, wherein the prompt can be configured/structured to cause the LIM to generate a specific statement with a probability of being classified with a particular attribute.

Token: a lexical unit/lexeme of language, e.g., a word, a term, an element, and suchlike, incorporated into a sentence, statement, etc.

Further, ranges A-n are utilized herein to indicate a respective plurality of devices, components, statements, attributes, etc., where n is any positive integer.

Language models (LMs), and their application, are becoming commonplace in today's society in the form of artificial intelligence (AI) chatbots, generative AI applications, and suchlike. Language models (LMs) and large language models (LLMs) can be formed with a neural network that is highly complex, for example, comprising billions of weighted parameters. Training of LLMs can be conducted with large textual datasets, whereby the datasets can be formed using any suitable technology, such as web crawlers configured to crawl and retrieve digital content (e.g., web-crawled data) from the World Wide Web/websites, online discussions, and suchlike. Given the open, potentially unconstrained/unfiltered nature in which the dataset is generated, the dataset can be replete with multiple statements that are toxic and/or biased against one or more societal groups, wherein such statements can be endemic to societal dialogue, cyberbullying, cyber-aggression, and suchlike. Accordingly, owing to the source of the training data, LMs can exhibit undesirable, toxic behavior. For example, a dataset used to train a LLM may include statements such as “you are from country x, that is a backward country”, “you support political party y, such supporters have low IQ”, and other statements which are often based on one person/a first group trying to assert their moral/ethical superiority over another person/a second group.

The ubiquitous application of LLMs has engendered offensive statements, toxic sentences, etc., finding their way into enterprise applications such as, in a non-limiting list: (a) document summaries generated by a LLM, such as a summary of a legal documents, (b) statements presented by an automated chat support system, (c) statements generated by automated question and answer technologies, (d) document writing tools designed to provide words for sentence completion, and suchlike.

Unfortunately, the commonly heard adage of garbage in, garbage out is particularly pertinent, whereby a LLM that has been trained with a dataset that includes toxic statements and/or bias will perform in a manner of considering the toxic statements and/or bias to be acceptable terms/tokens/statements in the corpus comprising the training dataset, and accordingly will generate the toxic statements, etc., based thereon.

One approach to reduce the potential for a LLM to be trained with a dataset comprising a corpus of toxic/biased statements is to manage/edit the dataset to remove the toxic/biased statements. However, given the sheer volume of data in a dataset, that is both existing and continually being acquired during continued updating of the datasets, such an approach can be unwieldy to the point of being impossible.

An alternative approach, as described in the various embodiments presented herein, is to reduce the toxic/biased nature endemic to the currently existing one or more LLMs. Accordingly, it is desired that LLMs are controlled to generate toxicity-free language with the ability to mitigate toxic speech and bias in language generation.

Per the various embodiments presented herein, a causally aware attribute system can be applied to one or more LMs (e.g., in a plug and play approach), wherein the causally aware attribute system can be configured to correct the LM to generate statements having a desired attribute(s), e.g., operation of the LM is modified by the causally aware attribute system such that the LM generates statements having reduced toxicity and/or the toxicity is removed entirely, and/or the modified LM reduces the probability of a negative attribute being assigned to a statement generated by the LM.

The presented embodiments are configured to control/modify generation of statements/sentences/text by application of a causal framework of average treatment effect (ATE) combined with counterfactual augmentation of a statement(s), etc. Application of counterfactuals to masked tokens can be utilized to achieve token level ATE scores, wherein the ATE scores can indicate the contribution of a token towards association of the statement with an attribute of concern/interest. In an embodiment, a reduction in more than one attribute can be pursued concurrently during mitigation of toxicity, etc. In brief, ATE scores can be determined by identifying an attribute associated with a statement (e.g., including a probability of the attribute being associated with the statement), mask a token t of interest in the statement s, apply an alternative token t′ (e.g., a counterfactual), and determine subsequent probability of the attribute being associated with the statement with t′ replacing t.

Further, application of structural causal models (SCMs) can be utilized to identify causal attribute scores for toxicity, e.g., using a Lp-norm (LP) metric. SCMs can capture cause and effect of semantics of the statement on an attribute. By utilizing a SCM, fine-grained control of reductions in probability of negative attributes (e.g., reduction in toxicity, toxicity loss) passed to the LM during training with a dataset can be identified, subsequently leading to controlled subsequent generation of statements by the LM regarding toxicity mitigation and suchlike. By utilizing SCMs and counterfactuals across a statement (e.g., a complete statement), spurious correlation of toxicity with protected groups in toxic datasets can be identified and mitigated, for example, identifying spurious correlation between hate and minority groups can result in reduced correlation existing, wherein such spurious correlation can be a significant problem with existing LLMs.

In an embodiment, application of SCMs can be utilized in combination with causal language modelling (CLM) loss, such as loss in probability of an attribute being associated with a statement, e.g., via a toxic prompts dataset, to optimize for both perplexity as well as toxicity mitigation.

Further, the LM can be fine-tuned to optimize to minimize any losses. It is possible to use different data-sets for each attribute, and even weight the attributes as required to achieve an outcome of removal of toxic statements. Furthermore, in a situation comprising multiple datasets, the various embodiments can be utilized to train over the different attributes in a round-robin manner.

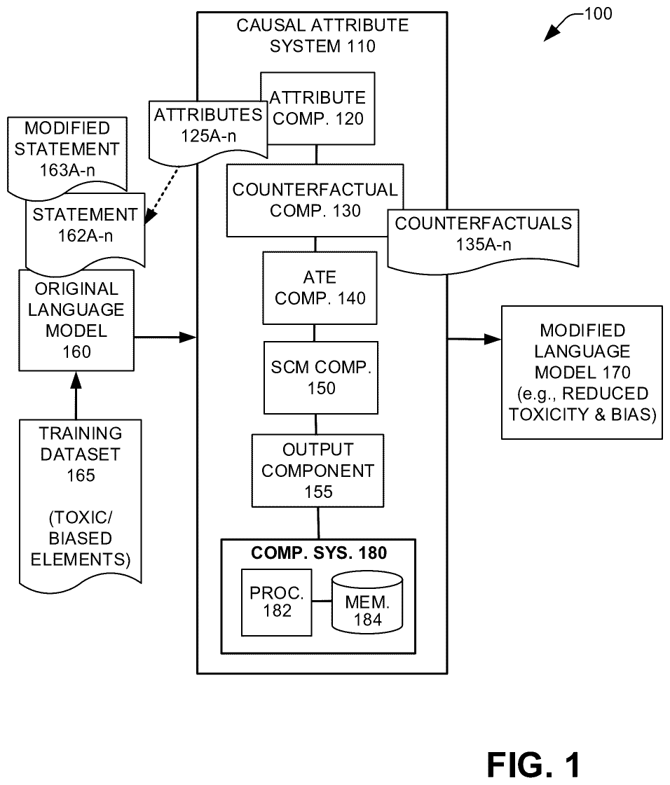

Turning now to the drawings, FIG. 1 illustrates a system 100 that can be utilized to detoxify/un-bias a LM, in accordance with one or more embodiments. System 100 includes a causal attribute system (CAS) 110 communicatively coupled to an original LM (first LM) 160 and a final/modified LM (second LM) 170, whereby LM 160 and LM 170 can be LLMs. As part of creating/generating/developing LM 160 the LM 160 can be trained with training dataset 165, wherein training dataset 165 can be generated from online sources/websites such as online discussions, web-crawled data, etc., as previously mentioned. As further previously mentioned, the LM 160 can generate one or more statements 162A-n, wherein the statements 162A-n can comprise tokens, etc., causing the statement 162A-n to have/be associated with respective attributes (e.g., toxic, hate, etc.) and/or bias as a result of being trained with dataset 165 comprising biased statements, tokens, etc.

As further described herein, CAS 110 can review the respective statements 162A-n generated by LM 160 and reduce the toxicity/bias inherent in the statements 162A-n, and accordingly, by implementing respective AI and machine learning (ML) technologies, for example, CAS 110 can reduce the toxicity/bias further inherent in the LM 160. As shown, CAS 110 can include an attribute component 120, a counterfactual component 130, an average treatment effect (ATE) component 140, a structural causal model (SCM) component 150, and an output component 155, wherein components 120, 130, 140, 150, and 155 can be communicatively coupled to each other as well as a computer system 180. Computer system 180 can include a memory 184 that stores the respective computer executable components 120, 130, 140, 150, and 155, and further, a processor 182 configured to execute the computer executable components stored in the memory 184.

Attribute component 120 can be utilized to classify a statement 162A-n with one or more attributes 125A-n. For example, attribute component 120 identifies statement 162A with an attribute 125A pertaining to a toxic statement, identifies statement 162B with an attribute 125B indicating demeaning content, and suchlike. Any attributes 125A-n can be determined based on the respective embodiments presented herein, for example, an attribute 125S can pertain to a sentiment of a statement, wherein the attribute 125S can be derived based on attribute component 120 applying a sentiment classifier to a statement 162A-n, while in another example, an attribute 125T can pertain to toxicity of a statement, wherein the attribute 125T can be derived based on attribute component 120 classifying statement 162A-n to be toxic. As further described, classification of an attribute can be based on one or more tokens.

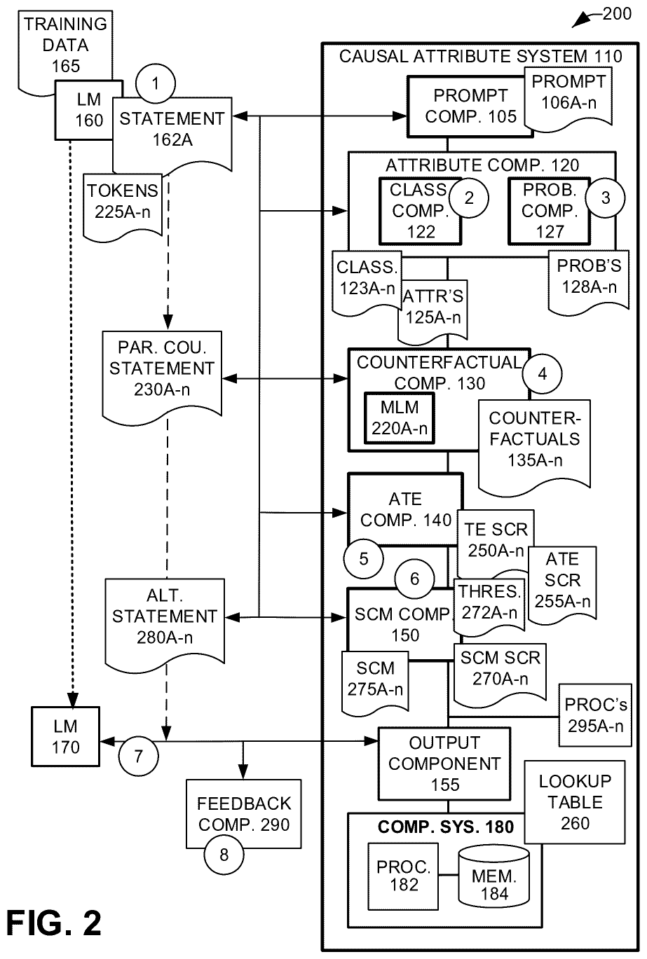

Counterfactual component 130 can be utilized to mask respective tokens/terms (e.g., tokens 225A-n, per FIG. 2) in a statement 162A-n, and further replace/insert other terms, aka counterfactuals 135A-n, for the masked term to enable identification of which term(s) in the statement 162A-n is causing the statement 162A-n to be classified/associated with the attribute 125A-n.

ATE component 140 can be configured to compute a treatment effect (TE) score for each respective counterfactual term 135A-n based upon the classified attribute 125A-n. For example, for each counterfactual term 135A-n, the statement 162A-n can be re-classified with regard to the attribute 125A-n and an ATE score generated.

SCM component 150 can be configured to apply a structural causal model (SCM) to determine an SCM score. The SCM score can be a combination of the respective ATE scores for all of the terms in a statement 162A-n and based thereon, a SCM score can be generated for the entire statement 162A-n.

Output component 155 can be utilized to interact with LM 160, and further cause LM 160 to finetune itself, e.g., such that LM 160 can be considered to be operating as modified LM 170.

The following example is presented to provide context regarding the various scenarios and embodiments presented herein:

Original statement 162A: People from country x hove a low IQ . . .
wherein, the one or more terms in the statement 162A that may be triggering/causing statement 162A to be classified with a toxic attribute 125A may not be the obvious one.

Per (A), the statement 162A can be broken down, with three terms identified:

$$\begin{matrix}\begin{matrix}Token 1 & & Token 2 & & Token 3\end{matrix} \\ \begin{matrix}\underline{People 1} & from & \underline{country x} & have a & \underline{low IQ}\end{matrix}\end{matrix} = toxic statement$$

Per (B), token 1 can be masked and replaced with the counterfactual term 135A=People2:

$$\begin{matrix}\begin{matrix}Token 1 & & Token 2 & & Token 3\end{matrix} \\ \begin{matrix}\underline{People 2} & from & \underline{country x} & are & \underline{low IQ}\end{matrix}\end{matrix} = still a toxic statement$$

Per (C), token 2 can be masked and replaced with the counterfactual term 135B=country y:

$$\begin{matrix}\begin{matrix}Token 1 & & Token 2 & & Token 3\end{matrix} \\ \begin{matrix}\underline{People 1} & from & \underline{country y} & are & \underline{low IQ}\end{matrix}\end{matrix} = still a toxic statement$$

Per (D), token 3 can be masked and replaced with the counterfactual term 135C=intelligent:

$$\begin{matrix}\begin{matrix}Token 1 & & Token 2 & & Token 3\end{matrix} \\ \begin{matrix}\underline{People 1} & from & \underline{country x} & are & \underline{intelligent}\end{matrix}\end{matrix} = \begin{matrix}classified as not being a \\ toxic statement\end{matrix}$$

A conventional approach to reduce the toxicity of a statement at LM 160 is to focus attention on replacing the respective entity (e.g., people/persons, country x/country y) to make the statement 162A have less probability of being classified with a toxic attribute 125A-n. However, per the foregoing, it is readily apparent that the term causing the statement to be classified with a toxic attribute 125A-n is token 3=low IQ and statement 162A becomes innocuous (e.g., below an acceptability threshold) when the counterfactual term 135A=intelligent is applied at token 3. Accordingly, the respective embodiments presented herein enable a cause and effect approach to be applied to statements 162A-n to identify the one or more tokens causing classification with a negative attribute 125A-n, rather than the conventional approach of replacing an entity People1 that is seemingly being maligned as a result of an analysis based on plain misleading correlation.

FIG. 2, illustrates a system 200 that can be utilized to detoxify/un-bias a language model, in accordance with an embodiment. In the following, operation of the respective components, devices, etc., included in the CAS 110 are described in conjunction with a sequential description 2-X of mitigating negative statements being generated by a LM 160.

At FIG. 2-1: as shown, a statement (first statement) 162A can be applied to the CAS 110 by the LM 160 (per FIG. 1). As previously described, statement 162A can be generated by LM 160 in response to question, a request to complete a statement, a prompt, and suchlike. In an embodiment, the CAS 110 can include a prompt component 105 configured to generate one or more prompts 106A-n to be applied to the LM 160, wherein the prompt component 105 can be configured to generate prompts 106A-n directed towards a particular theme for an attribute 125A-n.

At FIG. 2-2: in an embodiment, the attribute component 120 can be configured to receive and analyze the statement 162A. In a further embodiment, the attribute component 120 can include a classifier component 122, wherein the classifier component 122 can be configured with a series of classifiers 123A-n, such as a toxicity classifier 123A, a sentiment classifier 123B, a hate classifier 123C, an abusive classifier 123), a demeaning statement classifier 123E, a bias classifier 124n, and suchlike. The classifier component 122 can be configured to parse/analyze the content of statement 162A and further configured to determine one or more attributes 125A-n (e.g., toxic attribute 125A, sentiment attribute 125B, hate attribute 125C, abuse attribute 125D, a demeaning attribute 125F, a bias attribute 125n, and suchlike) pertaining to the statement 162A. In an embodiment, the classifier component 122 can be configured to classify the statement 162A as a function of respective tokens 225A-n included in statement 162A. The classifier component 122 and classifiers 123A-n can utilize any suitable technology, such as transformer-based deep learning technology, pre-trained to identify the respective attributes 125A-n of concern regarding hate speech, bias, etc., in the statement 162A.

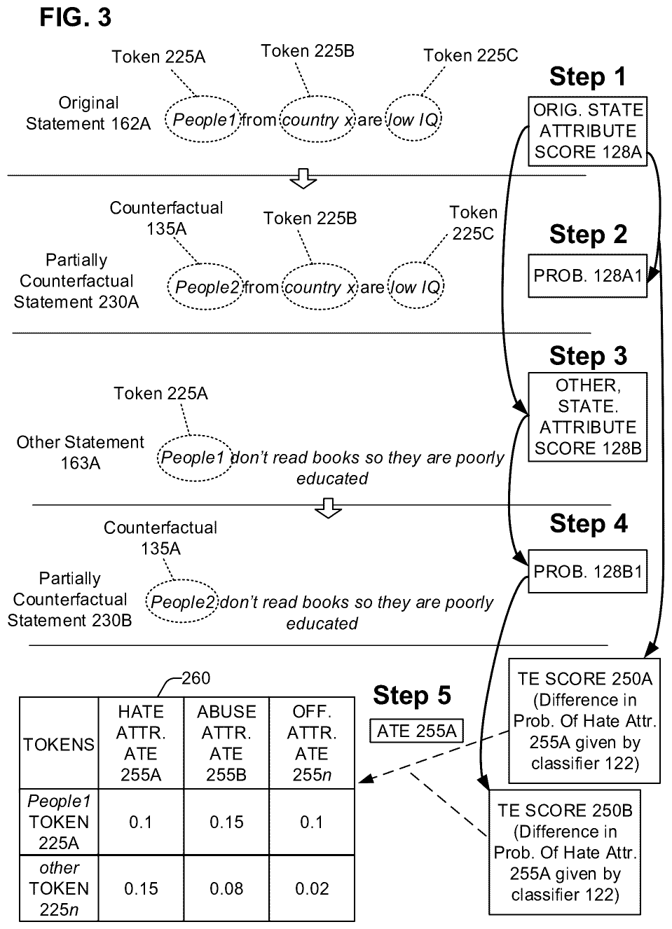

At FIG. 2-3: the attribute component 120 can further include a probability component 127, wherein the probability component 127 can be configured to determine respective probabilities (p) 128A-n of statement 162A being assigned a respective attribute 125A-n, such that:
p(attribute|statement)=p(attribute 125A|statement 162A), for example, defining a probability p of the original statement 162A being classified with toxic attribute 125A.

At FIG. 2-4: the counterfactual component 130 can be configured to receive and analyze the statement 162A classified with respective attributes 125A-n. Based in part on the attribute 125A-n that has been assigned to statement 162A, counterfactual component 130 can be configured to apply a masked language model (MLM) 220A-n to the classified statement 162A. A variety of MLM's 220A-n exist, wherein a first MLM (e.g., MLM 220H) can be directed towards, for example, identifying hate-based terms, while a second MLM (e.g., MLM 220A) can directed towards, for example, identifying abusive terms. In an embodiment, the counterfactual component 130 can be configured to identify the attribute 125A-n with which the statement 162A was classified, and further, select the MLM 220A-n that best fits the attribute 125A-n.

The counterfactual component 130 can utilize MLMs 220A-n to identify various tokens 225A-n in the statement 162A that may cause statement 162A to be classified with the respective attribute(s) 125A-n. A first token 225A (e.g., people1) in the original statement 162A can be identified and masked with substitute counterfactuals 135A-n applied thereto. In effect, the counterfactual component 130 receives the original statement 162A and, in a step-wise approach, replaces various identified tokens 225A-n in the statement 162A with substitute counterfactuals 135A-n to generate partially counterfactual statements 230A-n (aka partially modified statement(s)).

As further described, the counterfactual component 130 (e.g., in conjunction with the MLM 220A-n) can receive a collection of statements 162A-n from the LM 160 that all include the first token 225A. For example, LM 160 may have numerous (e.g., a hundred) other statements 162A-n present in the corpus of LM 160 that all contain the token 225A: people1. The counterfactual component 130 can be configured to identify a first counterfactual 135A and apply the first counterfactual 135A to each of the other statements 162A-n identified having the token 225A, people1, present in the respective statements 162A-n. The counterfactual component 130 can further identify an n^{th} counterfactual 135n and apply the n^{th} counterfactual 135n to each of the other statements 162A-n.

As further described, statements 162A-n, comprising respective tokens 225A-n included in the respective statement 162A-n being replaced with respective counterfactuals 135A-n, can be generated during causal analysis by SCM component 150. In an embodiment, the counterfactuals 135A-n can be innocuous terms/words or terms/words specifically provided in accordance with the MLMs 220A-n, e.g., a first set of counterfactuals 135A-n can be directed towards mitigating toxicity, a second set of counterfactuals 135A-n can be directed towards mitigating hate, etc.

At FIG. 2-5: in an embodiment, the partially counterfactual statements 230A-n can be received and processed by the ATE component 140, wherein the ATE component 140 can be utilized to determine a treatment effect (TE) score 250A-n for each respective token 225A-n replacement by a counterfactual term 135A-n in the partially counterfactual statements 230A-n, as further illustrated in FIG. 3. The TE score 250A-n can be determined by classifying (e.g., by the classifier component 122) the partially counterfactual statement 230A with regard to the attribute of interest, e.g., attribute 125A (e.g., a hate attribute 125A), and determining a new probability for which the attribute of interest is associated with the partially counterfactual statement 230A, e.g., to determine a degree with which the composition of the partially counterfactual statement 230A differs from the original statement 162A as a function of token 225A being replaced by the counterfactual 135A. Accordingly, the ATE component 140 can be configured to determine the probability (e.g., p2) of the attribute 125A being assigned to the partially counterfactual statement 230A. Further, the ATE component 140 can be configured to determine the difference in probability of the attribute 125A being assigned as a function of token 225A being replaced by the partially counterfactual statement 230A. The difference/change in probability is referred to herein as the treatment effect, TE score 250A-n. Hence, for token 225A being replaced with the partially counterfactual statement 230A, a TE score 250A can be generated for this specific incidence of replacement of token 225A. In an embodiment, a series of different counterfactual statements 230A-n can be generated from statement 162A, for which respective TE scores 250A-n can be determined. In a further embodiment, as mentioned, a collection of statements 162A-n in the LM 160 that include token 225A can also be identified/determined. For each of the statements in the collection of statements 162A-n in the LM 160, the token of interest (e.g., token 225A) can be replaced by various counterfactuals 135A-n, for which respective TE scores 250A-n can be determined.

In an embodiment, for the token 225A, all of the TE scores 250A-n (e.g., both in (a) versions of the statement 162A, or (b) statements 162A-n that include the token 225A) can be averaged to generate an average treatment effect (ATE) score 255A for that particular token 225A. Accordingly, the ATE score 255A provides an indicator of the effect of the token 225A causing the attribute 125A to be assigned to the original statement 162A, as well as all of the partially counterfactual statements 230A-n and the collection of statements 162A-n obtained from the LM 160 that include the token 225A. From the foregoing, a lookup table 260 can be created which includes the token 225A and the ATE score 255A associated with the token 225A. By repeating the foregoing determination of ATE score 255A-n for numerous tokens 225A-n, a vocabulary for the LM 160 can be generated, with each token 225A-n included in the lookup table/database 260 (e.g., stored in memory 184) and the associated ATE score 255A for the respective token in tokens 225A-n.

In an embodiment, multiple TE scores 250A-n can be concurrently determined for multiple attributes 125A-n, such that a first TE score 250X can be determined for a toxicity attribute 125T and a second TE score 250Y for a hate attribute 125H. Hence, the effect of applying a counterfactual term 135A-n can be determined across the collection of attributes 125A-n, to create an ATE score 255A-n. Thus, the TE scores 250A-n, ATE scores 255A-n, respective counterfactuals 135A-n, tokens 225A-n, statements 162A-n, partially counterfactual statements 230A-n, alternative statement 280A-n, etc., can be compiled and updated in the lookup table/database 260.

Turning momentarily to FIG. 3, the respective steps as previously described are presented. FIG. 3 illustrates replacement of tokens in a statement with respective counterfactuals, in accordance with one or more embodiments. As shown, at step 1 of FIG. 3, a probability 128A of attribute 125A being assigned to original statement 162A is determined. Per the transition from step 1 to step 2, token 225A (e.g., people1), in original statement 162A is masked and replaced by counterfactual 135A (e.g., people2) to create the partially counterfactual statement 230A, for which a probability 128A1 is generated.

As further shown in FIG. 3, the transition from step 1 to step 3 illustrates a different/other statement 163A being identified in LM 160, wherein the other statement 163A includes the token 225A, people1, and has a probability 128B for attribute 125A being assigned. At step 4, token 225A is replaced with counterfactual 135A (e.g., people2) to create the counterfactual statement 230B. Further, the probability 128B 1 of attribute 125A being assigned to partially counterfactual statement 230B can be determined.

Step 5 of FIG. 3 illustrates the TE score 250A being determined based on the difference in probability 128A and 128A1. Further, the TE score 250B is determined based on the difference in probability 128A and 128B1. The ATE score 255A is generated based on the average of all the TE scores 250A-n. Hence, while FIG. 3 illustrates ATE score 255A being an average of TE scores 250A and 250B, a respective ATE score 255A-n can be determined based on a difference in probabilities 128A-n, wherein the probabilities 128A-n can be a function of (a) a token 225A in an original statement 162A being replaced by a series of disparate counterfactuals 135A-n, and where the probabilities 128A-n can be a function of (b) a token 225A in an original statement 162A being replaced by a series of disparate counterfactuals 135A-n in a collection of other statements 163A-n that included the token of interest (e.g., token 225A). As further shown in FIG. 3, step 5, a lookup table 260 can be populated with respective ATE scores 255A-n determined for each token of interest (e.g., token 225A=people1, token 225n other term of interest), wherein the respective tokens 225A-n constitute a vocabulary for LM 160. In an embodiment, an ATE score 255A that has a small difference in probability resulting from replacing a token 225A with an innocuous counterfactual 135A can be an indicator that the token may have had minimal role in causing statement 163A to be classified with an attribute 125A. Alternatively, an ATE score 255A that has a larger difference in probability resulting from replacing a token 225A with a counterfactual 135A can be an indicator that the token may have played a role in causing statement 163A to be classified with an attribute 125A.

Per FIG. 2-6: the SCM component 150 can be configured to determine an SCM score 270A-n for other statements 162A-n that can be generated by the LM 160. In an embodiment, the SCM component 150 can determine a SCM score 270A-n for the various tokens 225A-n appearing in another statement 162A-n generated by the LM 160, for example, the other statements 162A-n that are generated in response to a prompt 106A-n. A SCM score 270A-n can be generated for a statement (e.g., statement 162B) based on the respective tokens 225A-n and associated ATEs 255A-n that are present in the other statement 162B. For example, LM 160 could generate a statement 162B, wherein the statement 162B can be broken down into respective tokens 225A-n. For each respective token in tokens 225A-n, the lookup table 260 can be accessed and the respective ATE score 255A-n can be extracted and applied to the statement 162B. Hence, where statement 162B comprises seven tokens 225A-G, statement 162B accordingly has associated with it (e.g., by SCM component 150) seven ATE scores 255A-G, e.g., ATE score 255A is assigned to/determined for statement 162A, ATE score 255B is assigned to/determined for statement 162B, . . . ATE score 255G is assigned to/determined for 162G. Based on the respectively assigned ATE scores 255A-G, the SCM component 150 can be configured to determine the SCM score 270A for the statement 162B based on the combination of ATE scores 255A-G, for example:

$$SCM score 270 A = ATE score 255 A + ATE score 255 B + ATE score 255 C + ATE score 255 D + ATE score 255 E + ATE score 255 F + ATE score 255 G .$$

The SCM score 270A can be compared with a threshold 272A-n representing an acceptable probability of an attribute being assigned to a particular statement generated by the LM 160. In the event that the SCM score 270A is above a threshold of acceptance 272A, e.g., a probability of 0.5, the LM 160 can be flagged to require further training. Alternatively, in the event of the SCM score 270A is below the threshold of acceptance 272A, the LM 160 can be considered to be operating in an acceptable manner.

As previously mentioned, based on having respective statements 162A-n that have been generated and had various counterfactuals 135A-n replacing masked tokens 225A included in the statements 162A-n, in conjunction with the various TE scores 250A-n and ATE scores 255A-n, it is possible to determine the SCM scores 270A-n for the entirety/combination of counterfactuals 135A-n utilized in each statement 162A-n. Accordingly, it is possible to determine the degree of success of reducing the toxicity, bias, etc., of a statement 162A-n. The SCM component 150 can be configured to select and utilize any respective SCM 275A-n pertaining to determining the SCM score(s) 270A-n of a statement 162A-n, wherein, in an embodiment, the selected SCM 275A-n can be based on the attribute 125A-n originally defined for the statement 162A. In an embodiment, one or more weightings can be applied to a SCM 275A-n to enable the respective SCM to be fine-tuned to encourage the SCM to generate statements having (a) less offensive statements and/or (b) reduced probability of a statement being associated with a toxic attribute.

Per the various embodiments presented herein and as previously mentioned, the level of success of replacing an offensive/biased statement 162A-n with less offensive/biased alternative statement 162A-n can be measured by a loss in probability of the probability p of a negative attribute(s) 125A-n initially assigned to a first statement (e.g., statement 162A-n) versus the probability p of the negative attribute(s) 125A-n assigned to a subsequently generated statement (e.g., statement 162B). The probability of an attribute 125A-n being assigned to a subsequent statement 162B can be compared with a threshold 272A-n to measure a degree of success of fine-tuning the LM 160 (e.g., to create LM170). For example, statement toxicity can be measured on a scale of 0.0→1.0. An innocuous statement 162K, e.g., containing no toxic tokens 225A-n, and no assigned attributes 125A-n pertaining to toxicity, bias, etc., can have a toxic probability of 0. Conversely, a statement 162L that is replete with toxic tokens 225A-n, for example, with a classified attribute(s) 125A-n indicating statement 162L is highly hate-filled, bias-laden, and suchlike, statement 162L can be determined to have a toxicity probability of 1. Generally, a statement having a determined toxicity of 0.0→0.5 can be considered to by unoffensive/non-toxic (e.g., is less than a threshold 272A of 0.5). Alternatively, a statement having a determined toxicity of 0.5→1.0 (e.g., above the threshold 272A of 0.5) can be considered to be mildly toxic/offensive through to extremely toxic/offensive. The toxicity value of 0.0→1.0 can be generated based on the probability of a given attribute of interest being identified/associated with a token 225A-n.

The effectiveness of replacing respective tokens 225A-n with respective counterfactuals 135A-n as part of the ATE score 255A-n process conducted by the ATE component 140, and (b) the SCM score process 270A-n conducted by SCM component 150, can be determined based on:

p(a_i|s)−p(a_i|s′)
where:
p is probability,
a_i=attribute (e.g., respective attribute 125A-n)
s=sentence/statement generated by LM 160 (e.g., respective statement 162A-n)
s′ alternative sentence/statement generated by a modified LM 170 (e.g., subsequently generated statement 162M), where:
p(a_i|s)=probability of original statement 162A being classified by a first attribute 125A, and
p(a_i|s′)=probability of subsequently generated statement 162M being classified by the first attribute 125A.

The SCM score 270A-n can be alternatively represented as:

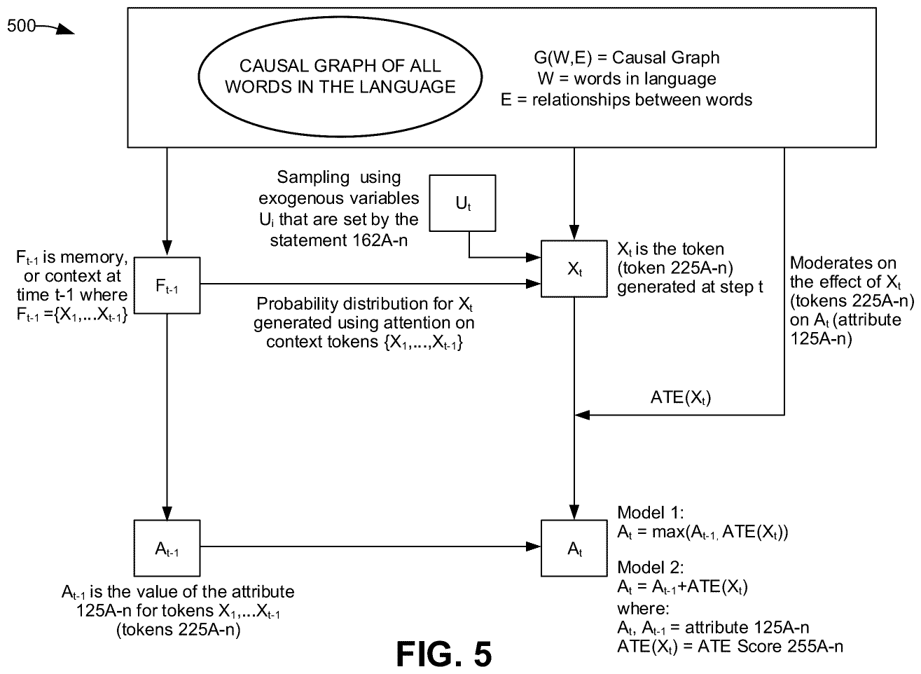

H(statement 162M)=∥H_{U1},H_{U2}, . . . ,H_{Um}∥_{P}
per a Lp norm metric of the tokens 225A-n present (e.g., originally present in statement 162A-n) and the counterfactuals 135A-n utilized, TE scores 250A-n, ATE scores 255A-n, attributes 125A-n, probabilities 128A-n, any exogenous variables (Uᵢ, per FIG. 5), and suchlike.

Per FIG. 2-7: based upon the application of the counterfactuals 135A-n, and alternative statements 280A-n generated based thereon (e.g., an original statement 162A having respective tokens 225A-n replaced with counterfactuals 135A-n), the alternative statement 280A-n can be applied to the LM 160 (e.g., by output component 155) to reduce the inherent toxicity of the LM 160, wherein the LM 160 having the alternative statements 280A-n applied thereto, can be modified to form modified LM 170. Hence, per the embodiments presented herein, the behavior of LM 160 can be corrected to generate LM 170, achieving desired attributes (e.g., a low probability of triggering negative attributes 125A-n) in subsequent statements 162A-n generated by LM 170. Given the wealth of information present in the respective TE scores 250A-n, ATE scores 255A-n, respective counterfactuals 135A-n, tokens 225A-n, statements 162A-n, partially counterfactual statements 230A-n, alternative statement 280A-n, etc., modification of the LM 160 to mitigate generation of toxic statements 162A-n, whereby the information can be utilized to fine-tune operation of the LM 160 (e.g., as LM 170).

In an embodiment, CAS 110 can be applied to any number of statements 162A-n generated by the LM 160. For example, a prompt 106A can be generated by prompt component 105 and applied to the LM 160 for which twenty five statements 162A-n can be generated by the LM 160 and concurrently processed by the CAS 110 with respect to reducing probability of generation/classification of attributes 125A-n for the respective twenty five statements 162A-n.

Per FIG. 2-8, in the event that an alternative statement 280A-n does not have a lower probability of causing an attribute 125A-n classifying the alternative statement 280A-n versus the probability of the original statement 162A-n being classified with the attribute 125A-n, the adapted statement can be flagged and the one or more reasons for the ineffectiveness of the alternative statement 280A-n can be reviewed, e.g., by the feedback component 290. In an embodiment, the feedback component 290 can utilize any of human-based review, AI, and/or ML, to determine why the particular instance of the alternative statement 280A-n was ineffectual. The respective AI, ML, etc., can be included in processes 295A-n, wherein processes 295A-n can be processes, operations, functions, workflows, algorithms, etc. It is to be noted that the processes 295A-n can be utilized by any of the components in CAS 110 presented herein, e.g., for determining probabilities 128A-n, generating counterfactuals 135A-n, determining TE scores 250A-n, ATE scores 255A-n, SCMs 275A-n, and suchlike. The knowledge learned during the review can be further subsequently applied to the CAS 110 to enable future analysis of tokens, application of attributes and counterfactuals, and subsequently generated adapted statements to improve the ability of the CAS 110 and the modified LM 170 to reduce probability of offensive/toxic/biased statements 162A-n. In an embodiment, the feedback component 290 can be utilized, such that in the event of CAS 110 is mis-identifying respective tokens 225A-n (e.g., counterfactuals 135A-n are being incorrectly generated), correction can be applied via feedback system 290, such that any of the attribute component 120, the counterfactual component 130, the ATE component 140, and/or the SCM component 150 can be configured to determine where the mis-identification is arising from and adjust accordingly (e.g., by increasing probability of non-toxic attributes 125A-n being generated).

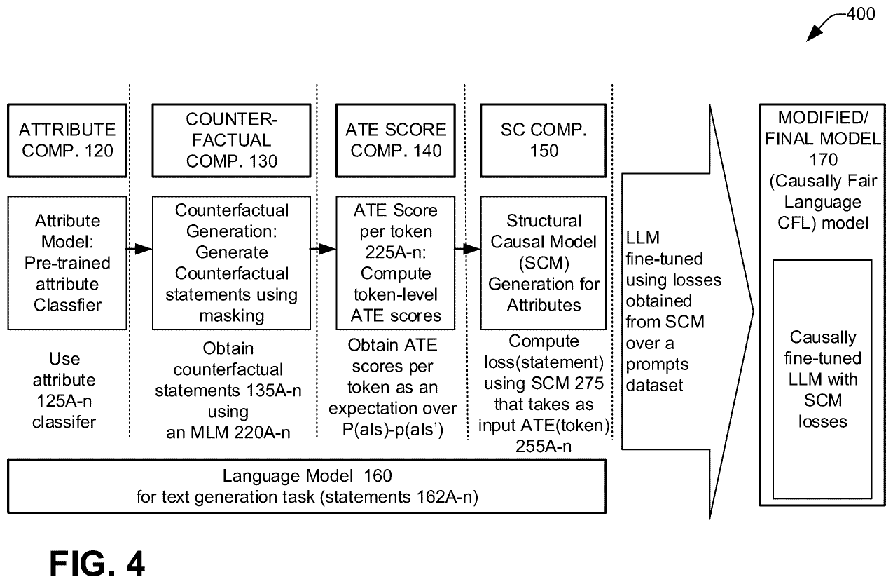

FIG. 4, system 400, presents a system model pipeline utilized to detoxify/un-bias a LM, in accordance with one or more embodiments. System 400 is a further representation of systems 100 and 200, as previously described. As shown in FIG. 4, an attribute component 120 can classify statements 162A-n generated by language model 160 with attributes 125A-n. Counterfactual component 130 can utilize a MLM 220A-n to generate and apply various counterfactuals 135A-n to the tokens 225A-n included in statements 162A-n. An ATE component 140 can be configured to generate TE scores 250A-n/ATE scores 255A-n for the respective counterfactuals 135A-n. SCM component 150 can be utilized to determine the loss (e.g., of toxicty/bias) wherein the SCM can generate H(subsequent statement 162n)=∥H_{U1}, H_{U2}, . . . , H_{Um}|ₚ. Accordingly, a causally fine-tuned LM 170, e.g., a LLM with SC M losses, can be generated. The LM 170 can implement AI and ML during the fine tuning process. For example, the LM 170 can generate a statement 162F. The SCM component 150 can apply an attribute 125F of interest, and based thereon, the SCM component 150 can generate a SCM score 270F for the statement 162F with respect to the attribute 125F. A determination can be made by the SCM component 150 regarding whether the SCM score 270F is above or below threshold 272F (wherein, threshold 272F=0.5, with a value of <0.5=statement is innocuous, value >0.5 statement is of concern). In the event of the SCM score 270F being below threshold 272F, the statement 162F can be considered to be innocuous/acceptable and can be presented. In the event of the SCM score 270F being above the threshold 272F, the statement 162F can be considered to be unacceptable (e.g., statement 162F is hateful) and the LM 170 is to further generate a statement 162A-n until the threshold 272F is met, at which point the LM 170 can be considered to be trained/finetuned for that particular attribute 125F.

FIG. 5, schematic 500, illustrates an example representation of a causal model (e.g., an SCM) as utilized to generate an attribute score of a statement, in accordance with an embodiment. As shown in FIG. 5, the respective elements and timings of a causal model, e.g., SCM 275A are presented. Xₜ (token 225A) is a token generated at time t, e.g., in a statement 162A, and Fₜ₋₁≡{X₁, . . . , Xₜ₋₁} refers to the set of all the tokens (tokens 225A-n) generated up to time t−1, e.g., for prior statements 162A-n. Attribute Aₜ₋₁ (e.g., any of attributes 125A-n) refers to the attribute score (e.g., based on TE score 250A-n/ATE score 255A-n) for a statement (e.g., statement 162) up to token Xₜ₋₁. Using the set of tokens {X₁, . . . , Xₜ₋₁}, the token Xₜ (token 225A) is randomly generated (wherein the randomness can be provided by the exogenous noise variable Uₜ), for which the attribute Aₜ is subsequently determined. Two models for attribute Aₜ are derived, model 1: Aₜ=max (Aₜ₋₁, ATE(Xₜ)) and model 2: Aₜ=Aₜ₋₁+ATE(Xₜ), whereby Aₜ and Aₜ₋₁ are attributes 125A-n and ATE(Xt) is ATE score 255A-n.

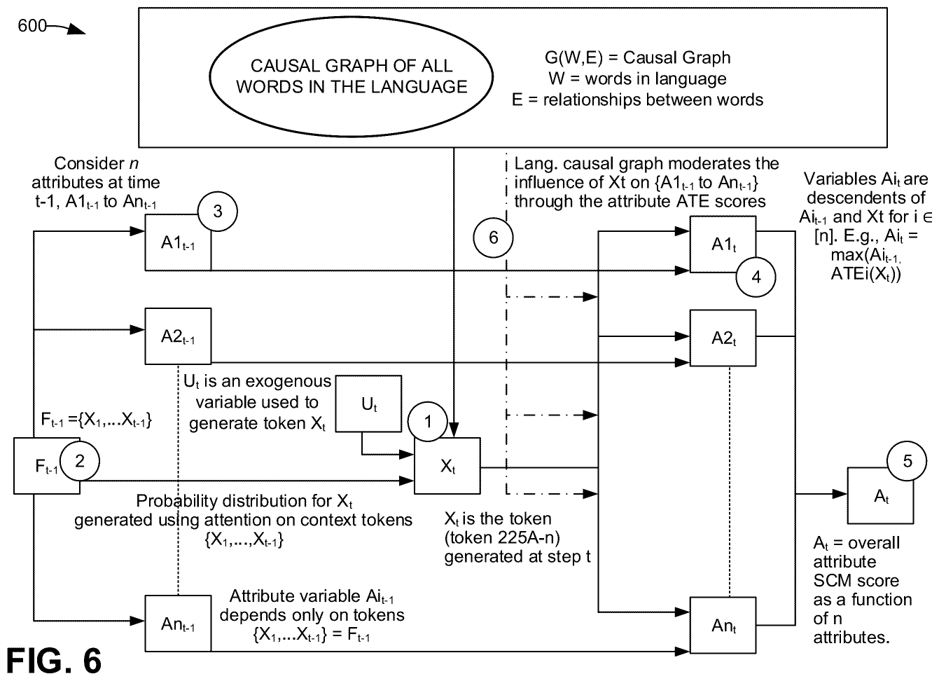

FIG. 6, schematic 600, illustrates an example representation of a SCM configured to modify/modifying operation of an LM to reduce probability of the LM generating toxic statements, in accordance with an embodiment. As shown in FIG. 6, the causal graph depicts how a SCM 275A can be utilized for fine-tuning a LM 160 to create LM 170, in accordance with attributes 125A-n. In case of orthogonal, or unrelated attributes 125A-n, the SCM 275A-n may require training over multiple data domains that may prompt completions having a particular attribute, e.g., attribute 125A. At (1) a first token XV, token 225A, can be generated, wherein generation of the first token 225A can be generated as a function of an exogenous variable Uᵢ. At (2), token 225A can be further generated with reference to a probability distribution function Fₜ₋₁ ≡{X₁, . . . , Xₜ₋₁} regarding a set of all the tokens (tokens 225A-n) generated up to time t−1 prior to generation of token Xₜ. At (3), as shown the function Fₜ₋₁ can further influence the attributes A1ₜ₋₁−Anₜ₋₁ (attributes 125A-n) that exist and generated prior to generation of token 225A (Xₜ). At (4), the generation of the token Xₜ (e.g., at (1)) in conjunction with the prior associated attributes 125A-n in conjunction with the respective probabilities, counterfactuals, TE scores, and ATE scores, and owing to the language in LM 160 being tempered, token 225A can result in a lower probability of generation of attributes 125A-n, such that at (5) the attribute associated with token 225A has a lower probability of being a negative attribute. Hence, at (6), by applying the various embodiments presented herein of replacing tokens with counterfactuals, the subsequent output of statements 162A-n have a lower probability of being associated with a negative attribute.

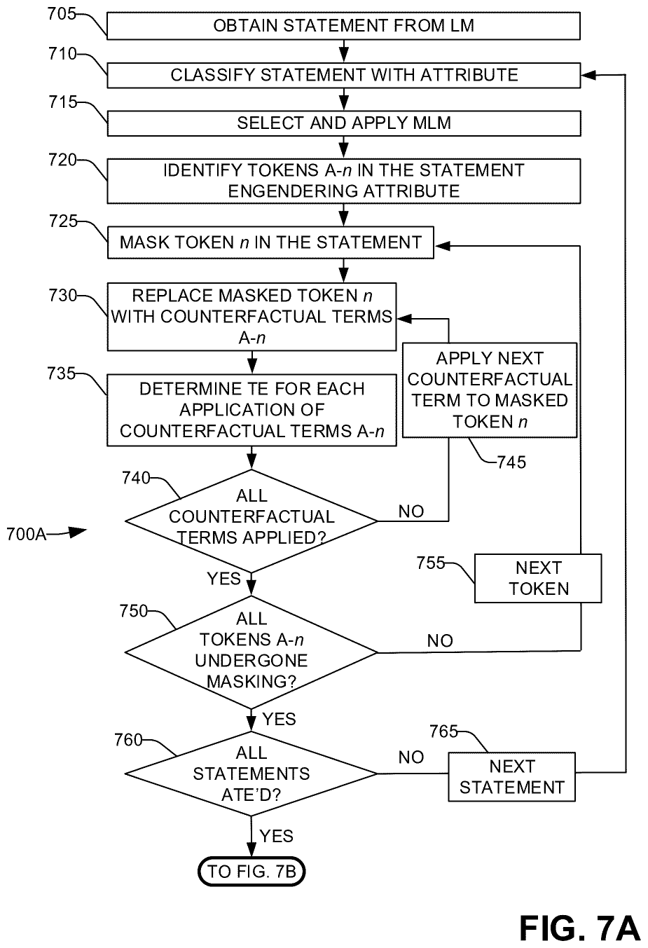

Turning to FIGS. 7A and 7B, schematics 700A and 700B illustrate a computer-implemented methodology to mitigate generation of negative-attribute statements by a LM, according to one or more embodiments. Schematics 700A and 700B present various steps in applying a causal attribute system (e.g., CAS 110), and the respective components included therein, to one or more statements (e.g., statements 162A-n) generated by an LM (e.g., LM 160), wherein the LM has been identified as, or has the potential to, generating statements that could be toxic, hateful, etc., in nature.

At 705, a statement (e.g., any of statements 162A-n) is generated by a LM (e.g., LM 160), wherein the LM was trained with data (e.g., training dataset 165) that is potentially replete with negative attributes (e.g., any of attributes 125A-n). In an example scenario, the statement can be generated by the LM in response to a question, etc., applied to the LM via a chatbot, or suchlike. In another example scenario, the statement can be generated in response to a prompt component (e.g., prompt component 105) configured to apply a prompt (e.g., prompt 106A-n) structured to engender generation of a statement having a particular attribute(s).

At 710, the statement can be classified by an attribute component (e.g., attribute component 120) with an attribute (e.g., any of attributes 125A-n), wherein the attribute can be used to identify the nature of the negative aspect of the statement (e.g., toxic, hateful, etc., as previously described). The attribute component can be configured to utilize a classifier component (e.g., classifier component 122) configured to identify/classify the statement regarding the one or more attributes with which the statement pertains. The attribute component can be configured to utilize a probability component (e.g., probability component 127), such that, as part of the classification process, a baseline probability (e.g., one or more probabilities 128A-n) can be determined regarding a probability p of the statement being classified with a first attribute.

At 715, a MLM (e.g., any of MLMs 220A-n) can be selected by a counterfactual component (e.g., counterfactual component 130) to be applied to the statement. The counterfactual component can be configured to select the respective MLM based on/in accordance with the selected/identified attribute.

At 720, the counterfactual component can be further configured to, in conjunction with application of the selected MLM, identify tokens (e.g., tokens 225A-n) in the statement to be masked. In an embodiment, the respective tokens can contribute to the negative nature of the statement, as identified during classification with the attribute.

At 725, the counterfactual component can be further configured to replace the masked tokens with pertinent counterfactuals (e.g., counterfactuals 135A-n). The counterfactual component can be configured to mask a token in the statement, wherein during a first pass of the counterfactual component, the first token in the statement can be masked, with an n^{th} token being masked during a subsequent n^{th} pass.

At 730, the counterfactual component can be further configured to replace the respective masked token with a counterfactual (e.g., any of counterfactuals 135A-n).

At 735, an ATE score component (e.g., ATE component 140) can be configured to determine a TE score (e.g., TE scores 250A-n) for each counterfactual that has been applied to the statement. As previously mentioned, a TE score is a probability that the statement and the respectively applied counterfactual would be classified with the attribute. The ATE score component can be further configured to store the respective ATE scores, TE scores, statements, counterfactuals, etc., in a lookup table (e.g., lookup table/database 260), wherein the lookup table can be located in system memory (e.g., memory 184).

At 740, the counterfactual component can be further configured to determine whether all of the counterfactuals have been applied to the current token of interest in the statement. In response to a determination of NO, not all of the counterfactuals have been applied to the current token of interest, methodology 700A can advance to 745, wherein the next counterfactual can be selected and applied to the masked token, with methodology returning to 730 for the next counterfactual to be applied to the masked token.

At 740, in response to a determination of YES, all of the counterfactuals for that token have been applied, methodology 700A can advance to 750.

At 750, the counterfactual component can be further configured to determine whether all of the tokens in the statement that have been identified to be masked have undergone masking with the associated counterfactuals applied thereto. In response to a determination that NO, not all of the identified tokens have been masked and replaced with counterfactuals, methodology 700A can advance to 755, with the next identified token being selected for masking and counterfactuals applied thereto. Methodology 700A can further return to 725 for the next token to be masked, counterfactuals applied, and TE scores determined, as previously described.

At 750, in response to a determination of YES, all of the identified tokens have been masked, counterfactuals applied, and TE scores determined, methodology 700A can advance to 760, for a SCM score to be determined for the alternative statement (e.g., statement 280A-n).

At 760, the respective steps 705 to 755 can be applied to other statements (e.g., other statements 162B-n) that include the token (e.g., token 162A) of interest in the original statement (e.g., statement 162A). At 760, a determination can be made regarding whether all of the statements (e.g., statements 162A-n) comprising the token (e.g., token 225A) have undergone the counterfactual process, and the further the TE score/ATE score have been generated. In response to NO, not all statements have been analyzed, methodology 700 can advance to 765, whereupon the next statement can be selected for review, whereupon the next statement can be classified with the attribute of interest, etc.

At 760, in the event of all the statements have been reviewed and respective TE scores generated, methodology 700 can advance to FIG. 7B.

At FIG. 7B, step 770, the ATE component can be configured to generate an ATE score for each token of interest. As previously described, the respective TE scores can be compiled, (e.g., by the ATE component 140) for a token. The ATE component can be further configured to determine an ATE score for the token, wherein the ATE score is an average of the TE scores generated for the token (e.g., in an original statement 162A and/or other statements 162B-n that include the token).

At 780, as each ATE score is generated by the ATE component, the token and the ATE score can be saved by the ATE component in a lookup table/database (e.g., lookup table 260). As mentioned, respective ATE scores can be generated for each attribute. Fence, as the lookup table is populated with tokens, the respective ATE scores for the various attributes can be compiled. Accordingly, a vocabulary can be generated for the language model (e.g., LM 160), comprising the wherein the token of interest can populate a lookup table (e.g., lookup table 260) in conjunction with the respective ATE scores.

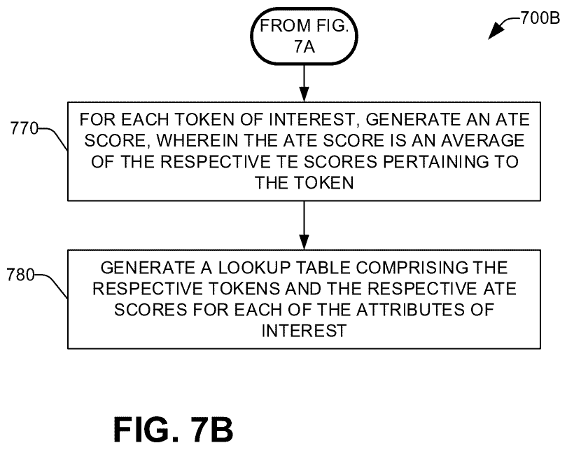

Turning to FIG. 8, schematic 800 illustrates a computer-implemented methodology to finetune a language model, according to one or more embodiments.

At 810, a prompt (e.g., prompt 106A-n) can be generated by a prompt component (e.g., prompt generation component 105). The prompt can be configured such that a particular attribute (e.g., any of attributes 125A-n) can be targeted.

At 820, the prompt can be directed at a language model (e.g., an original language model LM 160 or a modified language model LM 170), wherein the language model can be configured to generate one or more statements (e.g., statements 162A-n) based on, and in response to, the prompt.

At 830, for each of the respective statements generated by the language model, an ATE component (e.g., ATE component 140) can be configured to identify respective tokens (e.g., tokens 225A-n) present in the respective statement.

At 840, for each identified token, a lookup table (e.g., lookup table 260) can be accessed by the ATE component. As previously mentioned, the lookup table can include the respective token as well as ATE scores (e.g., ATE scores 255A-n) generated for each respective attribute of interest.

At 850, for each token in the statement, the respective ATE score can be applied. Further, a SCM component (e.g., SCM component 150) can be configured to determine a SCM score (e.g., SCM score 270A-n) for the statement having the ATE scores applied thereto.

At 860, the SCM component can be configured to compare the SCM score for the statement with a threshold (e.g., threshold 272A-n), wherein the threshold can be set to a value indicating whether the statement is innocuous/mildly offensive through to the statement is offensive/highly offensive. The threshold value can be set to an arbitrary value to enable the determination of inoffensive vs offensive. As previously mentioned, the threshold value can be set to 0.5 to enable the offensive versus inoffensive determination to be made.

At 860, a determination can be made by the SCM component regarding whether the SCM score is below the threshold. In the example embodiment, in the event of NO the SCM score is not below (or equal) the threshold, a determination can be made that the language model needs further training, and methodology 800 can advance to 870. In an embodiment, as previously mentioned, the language model can have associated AI and ML technologies (e.g., processes 295A-n) available such that in the event of a statement generated in response to a prompt does not have an acceptable level (e.g., above a threshold) of offensiveness, then the model can undergo further training/finetuning. At 870, the next statement can be retrieved/generated by the language model. In an embodiment, the AI and ML technologies can take into account that the first statement was determined to still have an unacceptable level of offensiveness, and accordingly, the language model can further self-finetune operation of the language model with a goal of generating, in response to a prompt, a statement having an acceptable level of offensiveness. Methodology 800 can return to 830 for the next statement to be reviewed regarding the language model generating offensive statements.

At 860, in the event of a determination, e.g., by the SCM component, that the SCM score is less than the threshold value, a determination can be made that the language model has been finetuned to correctly respond to a prompt. However, review of statements generated by the language model can be continually reviewed to ensure long term operation of the language model.

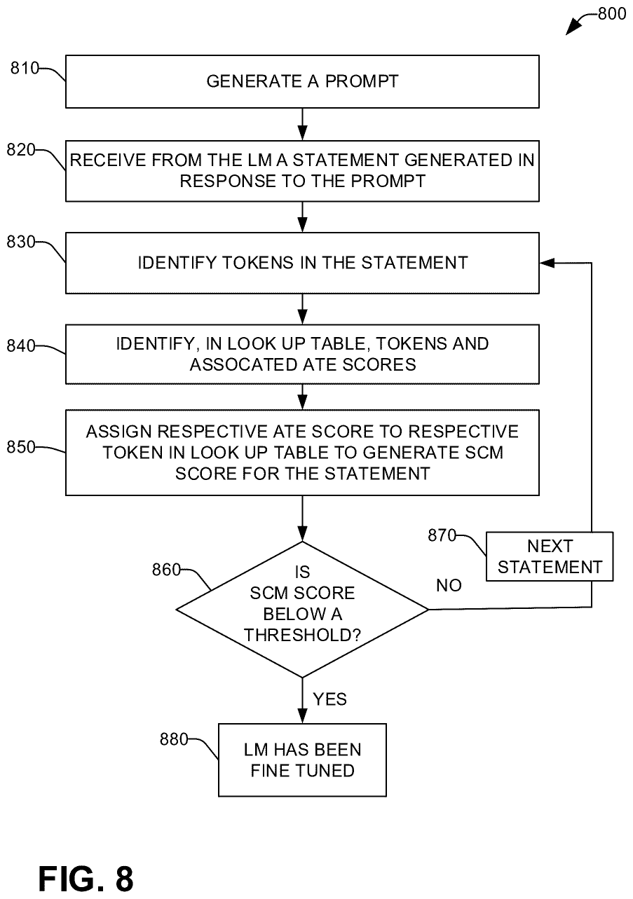

FIG. 9, chart 900 presents a plot of Expected Maximum Toxicity for various completed statements, in accordance with an embodiment. The x-axis presents input buckets of toxicity from 0-100, wherein 0 is no toxicity and 100 indicates statement (e.g., statement 162N) is highly toxic. The y-axis presents output toxicity, wherein, as previously described, 0.0 indicates statement has zero probability of association with a negative attribute, while 1.0 indicates statement has high probability (e.g., 100%) of association with a negative attribute, wherein non-toxic=less than 0.5, toxic=greater than 0.5. Line 910 of chart 900 indicates respective maximum toxicity (e.g., most toxic statement for a given bucket) of respective statements (e.g., statements 162A-n) generated by the LM 160 prior to being finetuned by the SCM component 150/SCM model 275A-n. Line 920 indicates respective maximum toxicity of statements 163A-n generated by the LM 160 (e.g., LM 170) after the LM 160 has undergone finetuning. Each “bucket” can include a number of statements having a given probability of toxicity (e.g., 100 statements are distributed through the buckets) generated by application of CAS 110/modified LM 170. As shown, for every instance, the maximum toxicity of a respective statement generated by the LM 160 (e.g., line 910) was reduced by the CAS 110/modified LM 170 (e.g., line 920). Accordingly, toxicity was reduced over all buckets by the various embodiments presented herein. “Maximum Toxicity” relates to the most toxic statement of all the statements in a given bucket.

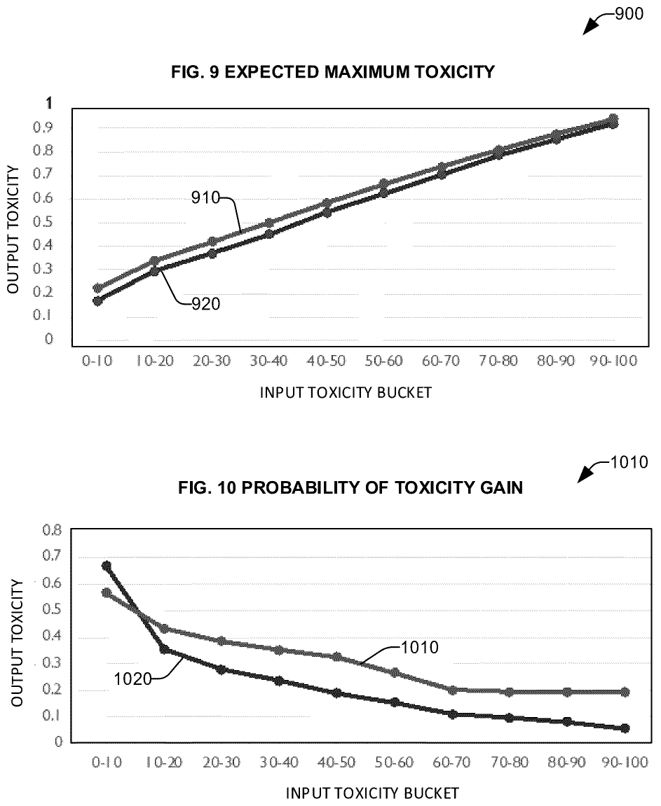

FIG. 10, chart 1000 presents a plot of Probability of Toxicity Gain for various completed statements, in accordance with an embodiment. The x-axis presents input buckets of toxicity from 0-100, wherein 0 is no toxicity and 100 indicates a statement is highly toxic. The y-axis presents output toxicity, wherein, as previously described, 0.0 indicates statement has zero probability of association with a negative attribute, while 1.0 indicates statement has high probability (e.g., 100%) of association with a negative attribute, wherein non-toxic=less than 0.5, toxic=greater than 0.5. Here, the probability of a statement gaining in toxicity is presented. As shown, for LM 160 operating in an original mode, plot 1010 indicates the probability of toxicity gain for a respective statement for a given bucket. Alternatively, when the LM 160 has been modified by CAS 110/modified LM 170, the probability of toxicity gain reduces, per line 1020. As shown, for line 1020, the probability of toxicity gain for a highly toxic statement in bucket 90-100 is virtually zero. Accordingly, toxicity was reduced over all buckets by the various embodiments presented herein.

TABLE 1 presents various test results which can be read in conjunction with FIGS. 9 and 10. As shown, statements generated by four causal-based models (Causal 1-4, e.g., SCMs 275A-D) performed better than both of the baseline models (e.g., 2 versions of LM 160) with regard to Expected Maximum Toxicity (e.g., per FIG. 9), and further with regard to Toxic Probability (e.g., per FIG. 10). As shown, as part of finetuning the LM 160, the statements generated as part of the SCM process present in FIG. 8, the Expected Maximum Toxicity and the Toxicity Probability reduced as finetuning was undertaken. As shown, original statements (e.g., original statements 162A-n) having an initial toxicity probability of 0.77/0.755 were reduced to during finetuning to ˜0.73, and further non-toxic statements were reduced from ˜0.3 to ˜0.265. Further, for Toxicity Probability, an average baseline toxicity of 0.972 reduced to an average modified toxicity of 0.966 and the average baseline non-toxicity average of 0.208 reduced to an average modified toxicity of 0.119.

TABLE 1
REDUCTION IN ATTRIBUTE PROBABILITIES
BETWEEN BASELINE STATEMENTS AND
ALTERNATIVE STATEMENTS.

| | EXP. MAX. TOXICITY | | TOXICITY PROBABILITY | |
|---|---|---|---|---|
| | (e.g., FIG. 9) | | (e.g., FIG. 10) | |
| MODEL | TOXIC | NON-TOXIC | TOXIC | NON-TOXIC |
| BASELINE 1 | 0.770 | 0.313 | 0.978 | 0.179 |
| (162A) | | | | |
| BASELINE 2 | 0.755 | 0.336 | 0.966 | 0.237 |
| (162B) | | | | |
| CAUSAL 1 | 0.732 | 0.263 | 0.967 | 0.111 |
| (280A) | | | | |
| CAUSAL 2 | 0.732 | 0.259 | 0.968 | 0.108 |
| (280B) | | | | |
| CAUSAL 3 | 0.729 | 0.268 | 0.966 | 0.120 |
| (280C) | | | | |
| CAUSAL 4 | 0.734 | 0.277 | 0.964 | 0.136 |
| (280D) | | | | |

From FIGS. 9 and 10 and TABLE 1, it is readily apparent that the various embodiments presented herein facilitate a reduction in the probability of generating a toxic statement, wherein the various embodiments can be utilized to modify an original LM 160 to reduce the inherent toxic nature of the LM 160 which has only been trained with an unfiltered, web-crawled training dataset 165.

As used herein, the terms “infer” “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in the CAS 110, e.g., attribute component 120, counterfactual component 130, ATE component 140, SCM component 150, and suchlike can include artificial intelligence (AI) and machine learning (ML) and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) one or more tokens 225A-n, (b) attributes (125A-n), both oppressive and non-oppressive, (c) counterfactuals 135A-n, (d) TE scores 250A-n and ATE scores 255A-n, (e) determination of a SCM 275A-n to apply, (f) application of thresholds 272A-n, (g) creating LM 170 from LM 160, and suchlike, as previously mentioned herein, can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., avoidance of an accident, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, probability of an accident in conjunction with avoidance of an accident, for example.

As described supra, inferences can be made, and operations performed, based on numerous pieces of information. For example, information/data regarding one or more tokens 225A-n included in a statement 162A-n, classifying the statement 162A-n with one or more attributes 125A-n, determining respective probabilities 128A-n, identifying counterfactuals 135A-n, generating TE scores 250A-n and ATE scores 255A-n, creation of partial counterfactual statements 230A-n and alternate statements 280A-n, application of one or more SCMs 275A-n during a finetuning process of LM 160 to LM 170, and suchlike, enabling a reduction in toxicity/bias/offensiveness, etc., of statements 162A-n subsequently generated by the LM 160/modified LM 170.

### EXAMPLE APPLICATIONS AND USE

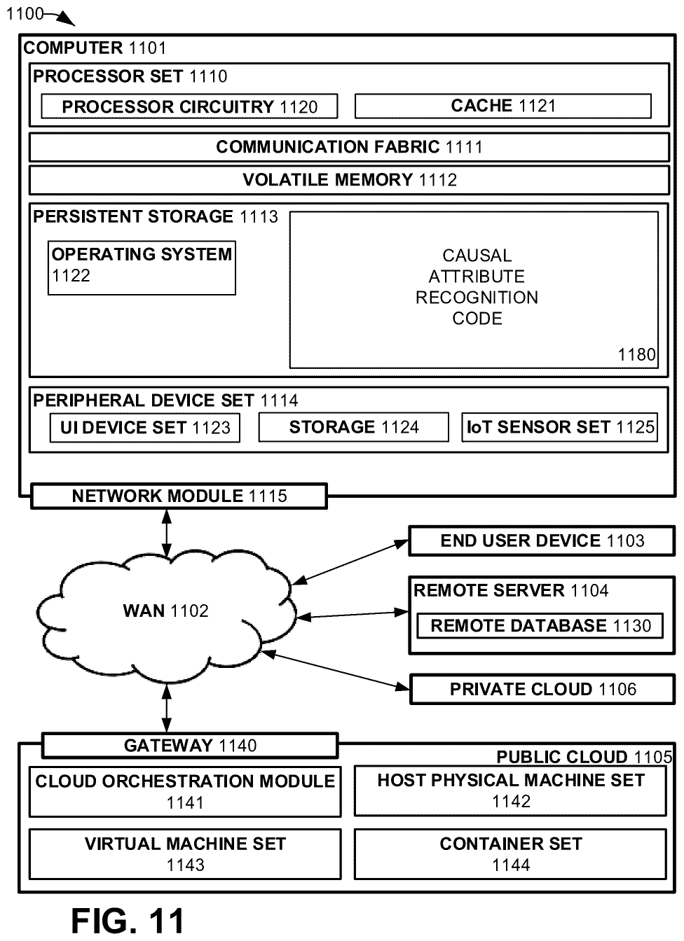

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as reducing the toxicity of statements generated by an LM (e.g., LM 160) by application of causal attribute recognition code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g. light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the Figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, w here the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system configured to modify operation of a language model (LM), comprising:
at least one processor; and
a memory coupled to the at least one processor and having instructions stored thereon, wherein, in response to the at least one processor, the instructions facilitate performance of operations, comprising:
determining whether the LM is generating a first statement having an unacceptable first probability of being associated with an attribute.

2. The system of claim 1, wherein the operations further comprise:
identifying a first token and a second token in a second statement causing the second statement to be associated with the attribute, wherein the second statement is generated by the LM.

3. The system of claim 2, wherein the operations further comprise:
replacing the first token in the second statement with a first counterfactual to create a first partially modified statement; and
determining a second probability of the first partially modified statement being associated with the attribute.

4. The system of claim 3, wherein the operations further comprise:
replacing the first token in the second statement with a second counterfactual to create a second partially modified statement; and
determining a third probability of the second partially modified statement being associated with the attribute.

5. The system of claim 4, wherein the operations further comprise:
generating a first average treatment effect (ATE) score based on an average of the second probability and the third probability, and
storing the first ATE score in a lookup table, wherein the first ATE score is stored with the first token.

6. The system of claim 5, further comprising:
replacing the second token in the second statement with a third counterfactual to create a third partially modified statement;
determining a fourth probability of the third partially modified statement being associated with the attribute;
replacing the second token in the second statement with a fourth counterfactual to create a fourth partially modified statement;
determining a fifth probability of the fourth partially modified statement being associated with the attribute;
generating a second ATE score based on an average of the fourth probability and the fifth probability, and
storing the second ATE score in the lookup table, wherein the ATE score is stored with the second token.

7. The system of claim 6, further comprising:
receiving the first statement, identifying the first token and second token in the first statement; and
determining a structural causal model (SCM) score for the first statement, wherein the SCM score comprises a combination of the first ATE score and the second ATE score.

8. The system of claim 7, further comprising:
comparing the SCM score with a threshold value; wherein
in the event of the SCM score has a value greater than the threshold value, the language model is identified as generating one or more statements having an unacceptable level of association with the attribute; or
in the event of the SCM score has a value less than the threshold value, the language model is identified as generating one or more statements having an acceptable level of association with the attribute.

9. The system of claim 1, wherein the attribute indicates the statement is at least one of toxic, abusive, offensive, demeaning, malicious, biased, or harmful.

10. The system of claim 1, wherein the LM has been trained with data generated web-crawled data.

11. The system of claim 1, wherein the LM is a large language model.

12. A computer-implemented method, comprising:
modifying, by a device comprising a processor, operation of a language model (LM) to generate a first statement having an acceptable probability of association with an attribute.

13. The computer-implemented method of claim 12, further comprising:
generating, by the device, a vocabulary for the LM, wherein the vocabulary comprises respective tokens identified in statements generated by the LM, the respective tokens have an associated average treatment effect (ATE) score, wherein a respective ATE score is derived from one or more treatment effect (TE) scores determined for the respective token.

14. The computer-implemented method of claim 13, further comprising:
identifying, by the device, in the first statement a first token and a second token:
identifying, by the device, a first ATE score for the first token and a second AEE score for the second token;
generating, by the device, a structural causal model (SCM) score for the statement, wherein the SCM score is a combination of the first ATE score and the second ATE score; and
comparing, by the device, the SCM score with a threshold, wherein:
in the event of the SCM score exceeds the threshold, the first statement has an unacceptable probability of association with the attribute; and
in the event of the SCM score does not exceed the threshold, the first statement has an acceptable probability of association with the attribute.

15. The computer-implemented method of claim 12, wherein the attribute indicates the statement is at least one of toxic, abusive, offensive, hateful, demeaning, malicious, biased, or harmful.

16. A computer program product stored on a non-transitory computer-readable medium and comprising machine-executable instructions, wherein, in response to being executed, the machine-executable instructions cause a machine to perform operations, comprising:
modifying operation of a language model (LM) to generate a first statement having an acceptable probability of association with an attribute.

17. The computer program product according to claim 16, wherein the operations further comprise:
generating, by the device, a vocabulary for the LM, wherein the vocabulary comprises respective tokens identified in statements generated by the LM, the respective tokens have an associated average treatment effect (ATE) score, wherein a respective ATE score is derived from one or more treatment effect (TE) scores determined for the respective token.

18. The computer program product according to claim 17, wherein the operations further comprise:
identifying in the first statement a first token and a second token;
identifying a first ATE score for the first token and a second ATE score for the second token;
generating a structural causal model (SCM) score for the statement, wherein the SCM score is a combination of the first ATE score and the second ATE score; and
comparing the SCM score with a threshold, wherein:
in the event of the SCM score exceeds the threshold, the first statement has an unacceptable probability of association with the attribute; and
in the event of the SCM score does not exceed the threshold, the first statement has an acceptable probability of association with the attribute.

19. The computer program product according to claim 16, wherein the attribute indicates the statement is at least one of toxic, abusive, offensive, demeaning, malicious, biased, or harmful.

20. The computer program product according to claim 16, wherein the original LM has been trained with data generated web-crawled data.
